(19) United States
(12) Patent Application Publication
(10) Pub. No.: US 2010/0216362 A1
(43) Pub. Date: Aug. 26, 2010

(54) Multi-layered clothing material

(76) Inventor: Cheng-Lin Chuang, Taichung (TW)

Correspondence Address: SAM CHEN, 7F-1, 293, ROOSEVELT ROAD, SEC 3, TAIPEI, TW

(21) Appl. No.: 12/393,069

(22) Filed: Feb. 26, 2009

(51) Int. Cl. B32B 5/02

(52) U.S. Cl. 442/66; 442/72; 442/59; 442/181

(57) ABSTRACT

A multi-layered clothing material in one embodiment includes an upper polymeric layer; an intermediate mixture layer; and a lower fabric layer. 2-5 wt % metal powder is mixed with 95-98 wt % adhesive to form an adhesive mixture which is applied on a releasable substrate together they are pressed and heated to form the mixture layer. The polymeric layer is formed on the mixture layer by pressing and heating. Both the polymeric layer and the mixture layer are formed on the fabric layer by pressing and heating. The metal powder is aluminum, titanium, zinc, or magnesium powder. The polymeric layer is formed of ePTFE, OPET, TPU, TPR, or TPE.

### BACKGROUND OF THE INVENTION

1. Field of Invention

The invention relates to multi-layered clothing materials and more particularly to such a multi-layered clothing material with improved characteristics including UV (ultraviolet) radiation protection, moisture penetration rate decrease, and body warmness increase.

2. Description of Related Art

Waterproof clothes are commercially available. However, such clothes are poor in maintaining body warmness.

Another typical clothing material comprises an ePTFE (expanded polytetrafluoroethylene) layer and a metal (e.g., aluminum, copper, silver, gold) or alloy layer which is formed on the ePTFE layer by evaporation in the manufacturing process. Clothes made of this material are waterproof, can prevent moisture from entering to contact the skin, and has IR (infrared) proof effect.

Still another typical clothing material comprises an upper layer of plastic, an intermediate layer formed of a mixture of activated carbon material and bio-degradable material, and a lower layer of fabric. This type of clothing material has specific applications.

U.S. Pat. No. 7,150,055 discloses a multi-layered bedclothes material. Thus, the need for improvement still exists.

### SUMMARY OF THE INVENTION

It is therefore one object of the invention to provide a multi-layered clothing material.

The above and other objects, features and advantages of the invention will become apparent from the following detailed description taken with the accompanying drawings.

### BRIEF DESCRIPTION OF THE DRAWINGS

FIG. 1 is a flow chart illustrating a process of manufacturing multi-layered clothing materials according to the invention;

FIG. 2 is an exploded view of one of the materials;

FIGS. 3, 4, 5A, and 5B are perspective views of the materials with different constituents respectively; and

FIG. 6 is a longitudinal sectional view of an item of clothing made of the material and the human body when a person wears the item of clothing.

### DETAILED DESCRIPTION OF THE INVENTION

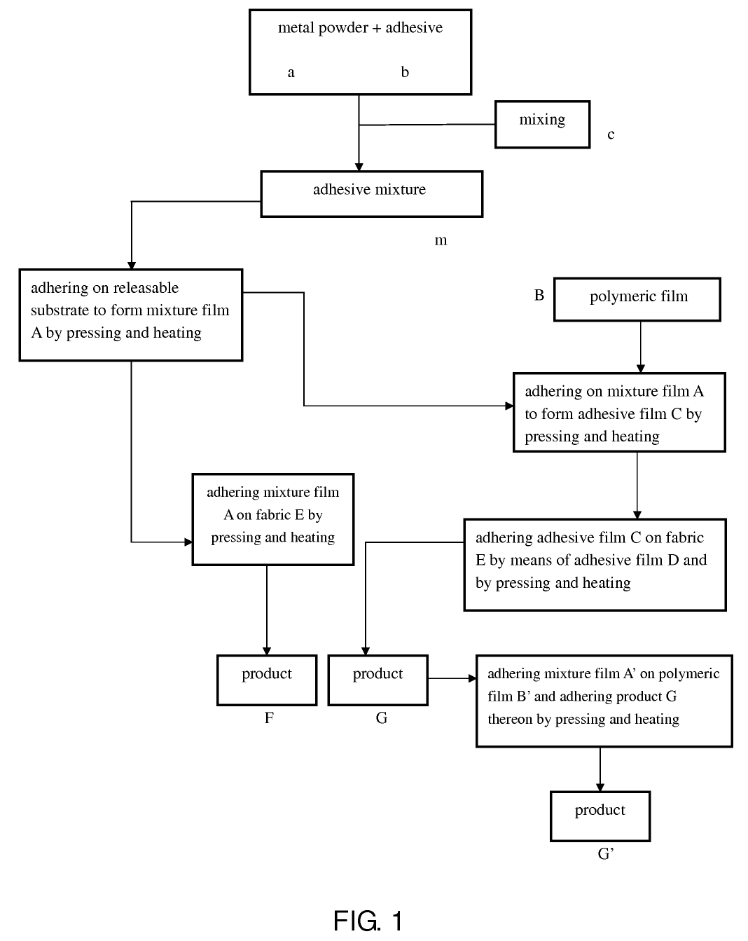

Referring to FIGS. 1 to 5B, a multi-layered clothing material manufactured in accordance with the invention comprises the following steps:

A metal powder a is comprised of aluminum, titanium, zinc, and magnesium. 95-98 wt % adhesive b is uniformly mixed C with 2-5 wt % metal powder a to form an adhesive mixture m.

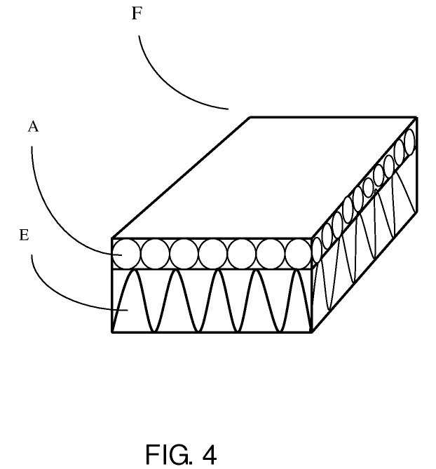

20-100 g/m² of the adhesive mixture m is applied on a releasable substrate. Next, it is heated and pressed to form a mixture film A. The mixture film A is in turn adhered on a fabric E to form a product F by pressing and heating (see FIG. 4).

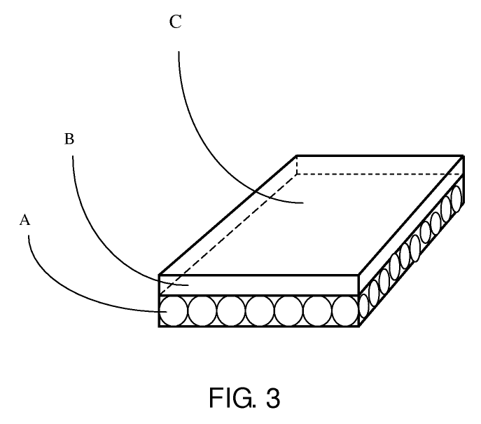

Alternatively, 40-43 wt % adhesive b and 2-5 wt % metal powder a are uniformly mixed together to form an adhesive mixture m. 20-100 g/m² of the adhesive mixture m is applied on a releasable substrate and they are heated and pressed to form a mixture film A. Next, 50-60 wt % polymeric film B is next applied on the mixture film A. Next, they are heated and pressed to form an adhesive film C comprising a top polymeric film B and a bottom mixture film A (see FIG. 3).

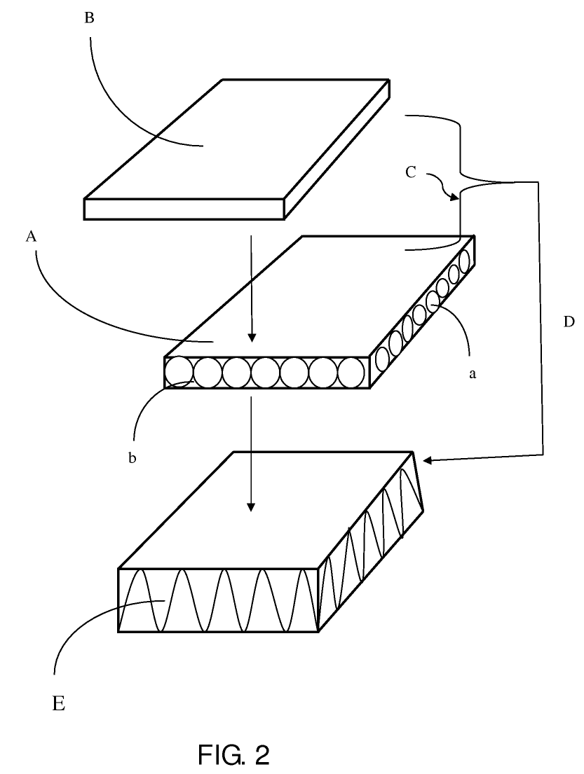

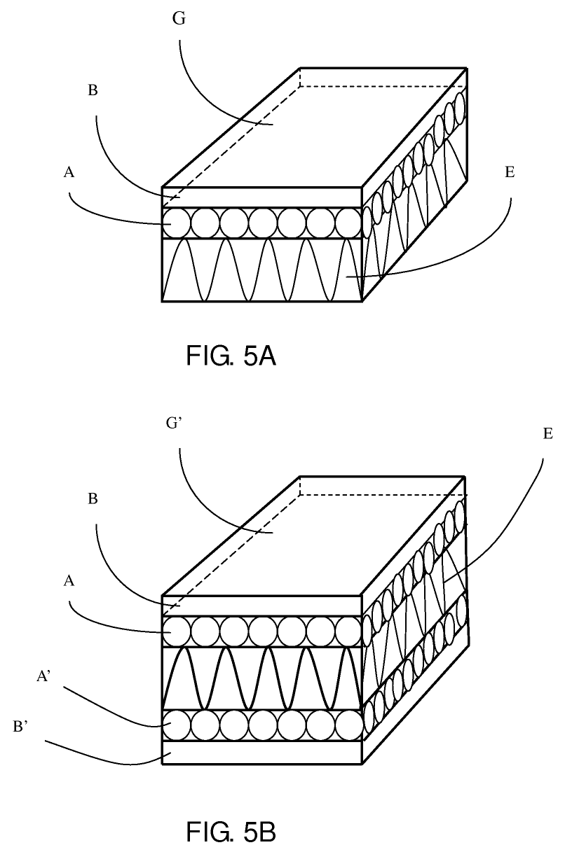

Moreover, the adhesive film C is adhered on a fabric E by applying an adhesive film D therebetween and heating to form a product G (see FIGS. 2 and 5A).

Moreover, a mixture film A′ is adhered on a polymeric film B′ and next the product G is adhered thereon to form a product G′ by pressing and heating (see FIG. 5B).

The adhesive film C has a thickness of 20 μm-45 μm. The adhesive mixture m has a thickness of 15 nm-150 nm. The polymeric film B is selected from a group consisting of ePTFE (expanded polytetrafluoroethylene), OPTE (oriented polyester), TPU (thermoplastic urethane), TPE (thermoplastic elastomer), and TPR (thermoplastic rubber). The fabric E can be chosen from any suitable materials.

The films A, B, C, and D have a moisture penetration rate between 30,000-45,000 g/m² per day and an IR reflection percentage between 85%-1 00%. The mixture film A is the “Raintex-AR200” available from Formosa Raintex Co., Ltd. The polymeric film B is the “Raintex-AR300” available from Formosa Raintex Co., Ltd. The adhesive film C is the “Raintex-ZR400” available from Formosa Raintex Co., Ltd. The adhesive film D is the “Raintex-MR450” available from Formosa Raintex Co., Lt. All of data listed in the above two paragraphs are tabulated in TABLE I below.

TABLE I

| | | Moisture penetration | IR reflection |
|---|---|---|---|
| Products | Adhesive mixture (wt %) | rate (g/m²/24 hrs) | (%) |
| Raintex-AR200 (film A) | Aluminum 2 wt % + adhesive 98 wt % | 45000 | 85 |
| Raintex-TR300 (film B) | Titanium 3.1 wt % + adhesive 96.9 wt % | 40000 | 92 |
| Raintex-ZR400 (film C) | Zinc 3.6 wt % + adhesive 96.4 wt % | 35000 | 98.5 |
| Raintex-MR450 (film D) | Magnesium 3.9 wt % + adhesive 96.1 wt % | 30000 | 100 |

It is seen that the higher percentage of metal powder the higher the IR reflection will be but the lower the moisture penetration rate will be.

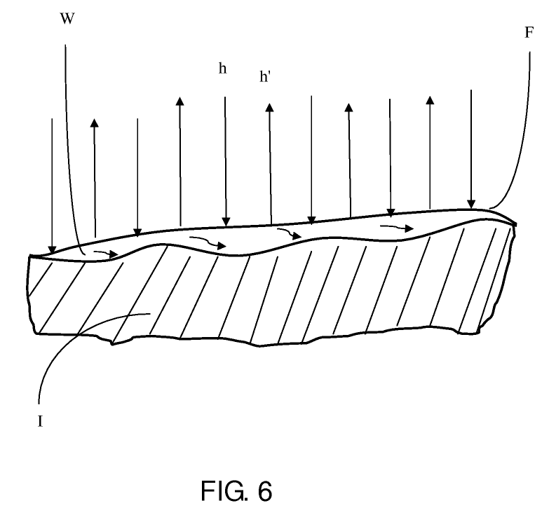

Referring to FIG. 6, a warm space W is formed between the human body I and a product F when a person wears an item of clothing made of the product F. An item of clothing made of the product of the invention has its warmness degree about 5-20% higher than that made of conventional waterproof clothing material. For example, a person wearing clothes made of the product of the invention can feel a degree of comfort since the clothes temperature is about 25° C.±2° C. Further, radiation h from the sun is greatly reflected as indicated by h′. Hence, the person may not feel uncomfortable when wearing the clothes.

Film A and fabric are the “Raintex-TAR200” available from Formosa Raintex Co., Ltd. Film B and fabric are the “Raintex-TTR300” available from Formosa Raintex Co., Ltd. Film C and fabric are the “Raintex-TZR400” available from Formosa Raintex Co., Ltd. Film D and fabric are the “Raintex-TMR450” available from Formosa Raintex Co., Ltd. The above data is further illustrated in TABLE II below.

TABLE II

| | Temperature range felt by |
|---|---|
| Products | the human body (25° C. ± X° C.) |
| Raintex-TAR200 (film A + fabric) | 25° C. ± 1.5° C. |
| Raintex-TTR300 (film B + fabric) | 25° C. ± 1.8° C. |
| Raintex-TZR400 (film C + fabric) | 25° C. ± 1.9° C. |
| Raintex-TMR450 (film D + fabric) | 25° C. ± 2.0° C. |

Moreover, the product of the invention can offer protection from UV (ultraviolet) radiation and IR (infrared) radiation.

### Embodiment 1

The “Raintex-AR200” with 2 wt % aluminum powder and 98 wt % adhesive b is chosen to uniformly mix to form an adhesive mixture m. Next, 25 g/m² of the adhesive mixture m is applied on a releasable substrate. Next, it is heated and pressed to form a mixture film A. Polymeric film B made of ePTFE having a thickness 20 μm is applied on the mixture film A in a speed of 25 m/minute. Next, they are adhered on a fabric E. Next, they are pressed and heated at a temperature between 90° C. and 140° C. Finally, a product is formed.

The mixture film A has a moisture penetration rate of 45,000 g/m² per day and IR reflection of 85% based on the test result of JISL1099B1. Moreover, the product is the “Raintex-TAR200 (film A+fabric)” which has a temperature range felt by the human body of 25° C.±1.5° C. based on the test method of FTTS-FA-10.43.

### Embodiment 2

The “Raintex-TR200” with 3.1 wt % titanium powder and 96.9 wt % adhesive b is chosen to uniformly mix to form an adhesive mixture m. Next, 25 g/m² of the adhesive mixture m is applied on a releasable substrate. Next, it is heated and pressed to form a mixture film A. Polymeric film B made of ePTFE having a thickness 30 μm is applied on the mixture film A in a speed of 25 m/minute. Next, they are adhered on a fabric E. Next, they are pressed and heated at a temperature about 135° C. Finally, a product is formed.

The mixture film A has a moisture penetration rate of 40,000 g/m² per day and IR reflection of 92% based on the test result of JISL1099B1. Moreover, the product is the “Raintex-TTR300 (film B+fabric)” which has a temperature range felt by the human body of 25° C.±1.8° C. based on the test method of FTTS-FA-10.43.

### Embodiment 3

The “Raintex-ZR400” with 3.6 wt % zinc powder and 96.4 wt % adhesive b is chosen to uniformly mix to form an adhesive mixture m. Next, 25 g/m² of the adhesive mixture m is applied on a releasable substrate. Next, it is heated and pressed to form a mixture film A. Polymeric film B made of ePTFE having a thickness 40 μm is applied on the mixture film A in a speed of 25 m/minute. Next, they are adhered on a fabric E. Next, they are pressed and heated at a temperature about 135° C. Finally, a product is formed.

The mixture film A has a moisture penetration rate of 35,000 g/m² per day and IR reflection of 98.5% based on the test result of JISL1099B1. Moreover, the product is the “Raintex-TZR300 (film C+fabric)” which has a temperature range felt by the human body of 25° C.±1.9° C. based on the test method of FTTS-FA-10.43.

### Embodiment 4

The “Raintex-MR400” with 3.9 wt % magnesium powder and 96.1 wt % adhesive b is chosen to uniformly mix to form an adhesive mixture m. Next, 25 g/m² of the adhesive mixture m is applied on a releasable substrate. Next, it is heated and pressed to form a mixture film A. Polymeric film B made of ePTFE having a thickness 40 μm is applied on the mixture film A in a speed of 25 m/minute. Next, they are adhered on a fabric E. Next, they are pressed and heated at a temperature about 145° C. Finally, a product is formed.

The mixture film A has a moisture penetration rate of 30,000 g/m² per day and IR reflection of 100% based on the test result of JISL1099B1. Moreover, the product is the “Raintex-TMR450 (film D+fabric)” which has a temperature range felt by the human body of 25° C.±2° C. based on the test method of FTTS-FA-10.43.

While the invention herein disclosed has been described by means of specific embodiments, numerous modifications and variations could be made thereto by those skilled in the art without departing from the scope and spirit of the invention set forth in the claims.

1. A multi-layered clothing material comprising:
an upper polymeric layer;
an intermediate mixture layer; and
a lower fabric layer;
wherein 2-5 wt % metal powder selected from the group consisting of aluminum, titanium, zinc, and magnesium powder is mixed with 95-98 wt % adhesive to form an adhesive mixture which is applied on a releasable substrate together they are pressed and heated to form the mixture layer; and
wherein the polymeric layer is formed of ePTFE (expanded polytetrafluoroethylene), OPET(oriented polyester), TPU (thermoplastic urethane), TPR (thermoplastic rubber), or TPE (thermoplastic elastomer).

2-8. (canceled)
